(19) United States
(12) Patent Application Publication
(10) Pub. No.: US 2013/0285943 A1
(43) Pub. Date: Oct. 31, 2013

(54) APPARATUS AND METHOD FOR EXECUTING TOUCH CONTROLLER FIRMWARE DOWNLOADED FROM EXTERNAL HOST TO CONTROL TOUCH PANEL

(71) Applicant: MEDIATEK INC., Hsin-Chu (TW)

(72) Inventors: Chung-Jen Kuo, Hsin-Chu City (TW); Yu-Hsuan Lin, Taichung City (TW); Chang-Po Ma, Hsinchu City (TW)

(73) Assignee: MEDIATEK INC., Hsin-Chu (TW)

(21) Appl. No.: 13/748,593

(22) Filed: Jan. 24, 2013

Related U.S. Application Data
(60) Provisional application No. 61/640,003, filed on Apr. 30, 2012.

(51) Int. Cl. G06F 3/041

(52) U.S. Cl. CPC G06F 3/0412
USPC 345/173

(57) ABSTRACT

An exemplary touch controller chip includes a volatile storage device, an interface unit and a control unit. The interface unit is arranged for receiving touch controller firmware outside the touch controller chip, and storing the received touch controller firmware into the volatile storage device. The control unit is arranged for executing the touch controller firmware stored in the volatile storage device to control a touch panel. In addition, an exemplary electronic device includes a touch controller chip and a host, wherein the touch controller chip has no non-volatile storage device used for storing touch controller firmware, and the host is arranged for transmitting the touch controller firmware to the touch controller chip.

### CROSS REFERENCE TO RELATED APPLICATIONS

This application claims the benefit of U.S. provisional application No. 61/640,003, filed on Apr. 30, 2012 and incorporated herein by reference.

### BACKGROUND

The disclosed embodiments of the present invention relate to controlling a touch panel, and more particularly, to an apparatus and method for executing touch controller firmware downloaded from an external host to control the touch panel.

Touch panel devices are now widely used in a variety of applications to act as user interfaces. In general, a touch panel device may include a touch panel and a touch controller, and the touch controller may transmit a detection result of a touch event (e.g., coordinate information of the detected touch event) to a host. Regarding a conventional design, the touch controller has a processor and a non-volatile memory integrated in the same chip, where the non-volatile memory (e.g., a flash memory) is used to store firmware of the touch controller, and the processor is used to execute the firmware read from the non-volatile memory to control driving and sensing of the touch panel.

However, as the flash memory is generally manufactured using a special semiconductor process, the production cost of the touch controller is increased inevitably. Thus, there is a need for an innovative touch controller design which can omit the non-volatile memory (e.g., the flash memory) for cost reduction.

### SUMMARY

In accordance with exemplary embodiments of the present invention, an apparatus and method for executing touch controller firmware downloaded from an external host to control the touch panel are proposed to solve the above-mentioned problem.

According to a first aspect of the present invention, an exemplary touch controller chip is disclosed. The exemplary touch controller chip includes a volatile storage device, an interface unit and a control unit. The interface unit is arranged for receiving touch controller firmware outside the touch controller chip, and storing the received touch controller firmware into the volatile storage device. The control unit is arranged for executing the touch controller firmware stored in the volatile storage device to control a touch panel.

According to a second aspect of the present invention, an exemplary electronic device is disclosed. The exemplary electronic device includes a touch controller chip and a host. The touch controller chip has no non-volatile storage device used for storing touch controller firmware. The host is arranged for transmitting the touch controller firmware to the touch controller chip.

According to a third aspect of the present invention, an exemplary method for controlling a touch panel is disclosed. The exemplary method includes at least the following steps: downloading touch controller firmware from a first device to a second device, wherein the first device and the second device are not integrated in a same chip; and executing the touch controller firmware on the second device for controlling the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic apparatus employing a proposed touch controller design according to a first embodiment of the present invention.

FIG. 2 is a diagram illustrating an embodiment of the clock gating unit shown in FIG. 1.

FIG. 3 is a flowchart illustrating a method performed on a touch controller chip for receiving the touch controller firmware and the control value from a host according to a first embodiment of the present invention.

FIG. 4 is a flowchart illustrating a method performed on a host for transmitting the touch controller firmware and the control value to the touch controller chip according to a first embodiment of the present invention.

FIG. 5 is a flowchart illustrating a method performed on a host for transmitting the touch controller firmware and the control value to a touch controller chip according to a second embodiment of the present invention.

FIG. 6 is a block diagram illustrating an electronic apparatus employing a proposed touch controller design according to a second embodiment of the present invention.

FIG. 7 is a flowchart illustrating a method performed on a touch controller chip for receiving the touch controller firmware and the control value from a host according to a second embodiment of the present invention.

FIG. 8 is a block diagram illustrating an electronic apparatus employing a proposed touch controller design according to a third embodiment of the present invention.

FIG. 9 is a flowchart illustrating a method performed on a touch controller chip for receiving the touch controller firmware and generating the control value according to a first embodiment of the present invention.

FIG. 10 is a flowchart illustrating a method performed on a host for transmitting the touch controller firmware to the touch controller chip according to a first embodiment of the present invention.

FIG. 11 is a block diagram illustrating an electronic apparatus employing a proposed touch controller design according to a fourth embodiment of the present invention.

FIG. 12 is a flowchart illustrating a method performed on a touch controller chip for receiving the touch controller firmware and generating the control value according to a second embodiment of the present invention.

FIG. 13 is a block diagram illustrating an electronic apparatus employing a proposed touch controller design according to a fifth embodiment of the present invention.

FIG. 14 is a flowchart illustrating a method performed on a touch controller chip for receiving the touch controller firmware and generating the control value according to a third embodiment of the present invention.

FIG. 15 is a block diagram illustrating an electronic apparatus employing a proposed touch controller design according to a sixth embodiment of the present invention.

FIG. 16 is a flowchart illustrating a method performed on a touch controller chip for receiving the touch controller firmware and generating the control value according to a fourth embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main concept of the present invention is to provide a touch controller which downloads the needed firmware from an external host when powered on. As the firmware is downloaded on demand, the touch controller does not need to have a non-volatile memory (e.g., a flash memory) implemented therein. In this way, the production cost of the touch controller is reduced due to omission of the special semiconductor process needed by the non-volatile memory. Further details are described as below.

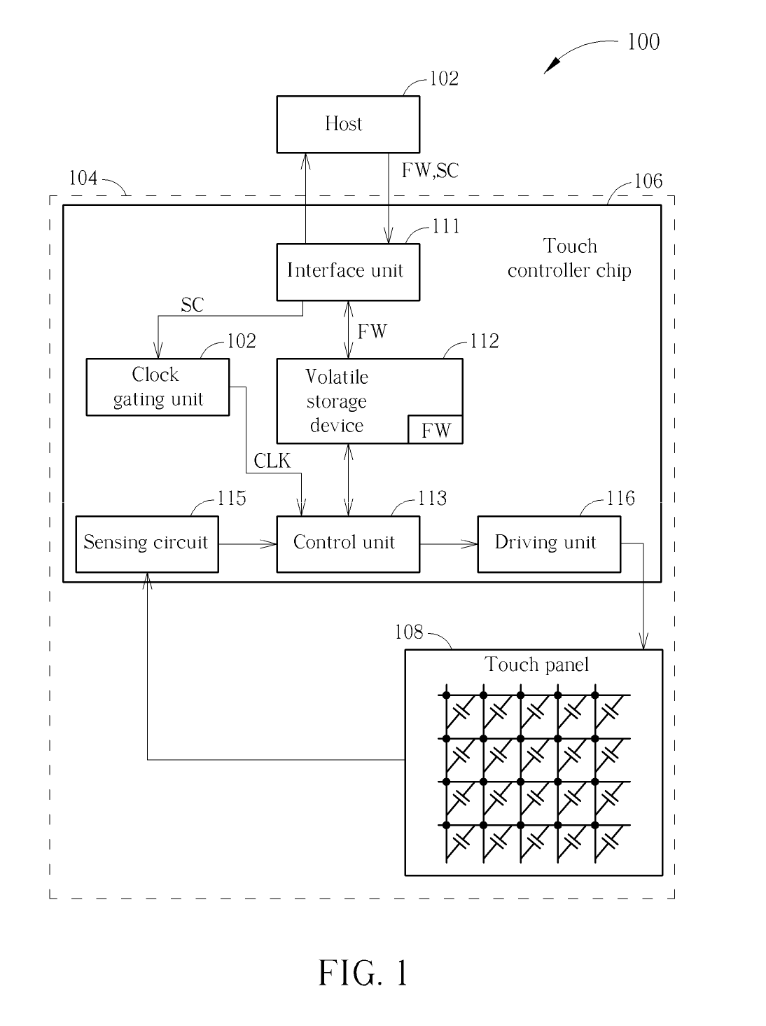

FIG. 1 is a block diagram illustrating an electronic apparatus employing a proposed touch controller design according to a first embodiment of the present invention. The electronic apparatus 100 has a host 102 and a touch panel device 104, where the touch panel device 104 includes a touch controller chip 106 and a touch panel 108. In this embodiment, the touch controller chip 106 is an SoC (System on Chip) coupled to the host 102 and the touch panel 108, and includes, but is not limited to, an interface unit 111, a volatile storage device 112, a control unit 113, a clock gating unit 114, a sensing circuit 115 and a driving circuit 116. The touch panel 108 is controlled by the touch controller chip 106, and includes a capacitive sensing medium having a plurality of drive lines (i.e., row traces) and a plurality of sense lines (i.e., column traces). The drive lines and the sense lines are formed by a transparent conductive material such as Indium Tin Oxide (ITO). In this embodiment, the drive lines and the sense lines are arranged in a matrix form such that the drive lines and the sense lines, as shown in FIG. 1, are perpendicular to each other. It should be noted that, at each intersection of one drive line and one sense line, there is no direct electrical contact between the drive line and the sense line. In other words, the intersection is a crossover point where the drive line and the sense line pass cross each other. As a result, the intersection may be regarded as a capacitive sensing node due to the fact that the drive line and the sense line at the intersection can essentially form two electrodes of a capacitor.

The touch controller chip 106 detects the capacitance variation at each capacitive sensing node for determining occurrence and coordinate of a touch event. Hence, the touch controller chip 106 has to determine a capacitance value at each capacitive sensing node. Specifically, the driving circuit 116 is controlled by the control unit 113 to generate a stimulation input to the touch panel 108, and then the sensing circuit 115 reads an analog sensing output from the touch panel 108 and generates a touch sense result to the control unit 113 for further processing. For example, an analog-to-digital converter (not shown) may be employed to convert the analog sensing output into the touch sense result. To put it simply, the control unit 113 is used to control the driving and sensing of the touch panel 108.

In this embodiment, the control unit 113 may be a micro control unit (MCU) or a digital signal processor (DSP). Therefore, the control unit 113 is capable of loading and executing the touch controller firmware FW to perform the designated touch panel control functions. Please note that the touch controller chip 106 has no non-volatile storage device (e.g., a flash memory) implemented for storing the touch controller firmware FW in a non-volatile manner. In other words, the control unit 113 does not load and execute the touch controller firmware FW from an internal non-volatile storage device of the touch controller chip 106. Instead, the control unit 113 is arranged to load and execute the touch controller firmware FW available in the volatile storage device 112 such as a static random access memory (SRAM), where the touch controller firmware FW is downloaded from the host 102 external to the touch controller chip 106. As the host and the touch controller are not integrated in the same chip, the interface unit 111 of the touch controller chip 106 is implemented to communicate with the external host 102 via a bus. By way of example, the bus may be an inter-integrated circuit (I2C) bus or a serial peripheral interface (SPI) bus, depending upon actual design requirement. Specifically, the interface unit 111 is arranged for receiving the touch controller firmware FW from the host 102 outside the touch controller chip 106, and storing the received touch controller firmware FW into the volatile storage device 112. The control unit 113 is therefore arranged for executing the touch controller firmware FW stored in the volatile storage device 112 to control the driving and sensing of the touch panel 108. As there is no internal non-volatile storage device (e.g., flash memory) implemented in the touch controller chip 106, the production cost of the touch controller chip 106 can be effectively reduced. It should be noted that the host 102 is generally equipped with a large-sized non-volatile storage device, and the size of the touch controller firmware FW is generally small. Thus, storing the touch controller firmware FW on the host 102 has a negligible impact on the host 102.

As mentioned above, the volatile storage device 112 is used to buffer the touch controller firmware FW due to the fact that the touch controller chip 106 has no non-volatile storage device used for firmware storage. As the touch controller chip 106 will lose the contents stored in the volatile storage device 112 after powered off, the touch controller chip 106 has to download the touch controller firmware FW from the host 102 each time the touch controller chip 106 is powered on. Before the touch controller firmware FW is ready for execution on the touch controller chip 106, the control unit 113 should be stopped from loading and executing the incomplete touch controller firmware. Specifically, the control unit 113 is initially locked (halted) by default when the touch controller chip 106 is powered on, and is unlocked later to execute the touch controller firmware FW provided by the host 102 for controlling the touch panel 108. In this embodiment, locking and unlocking of the control unit 113 is controlled by the clock gating unit 114.

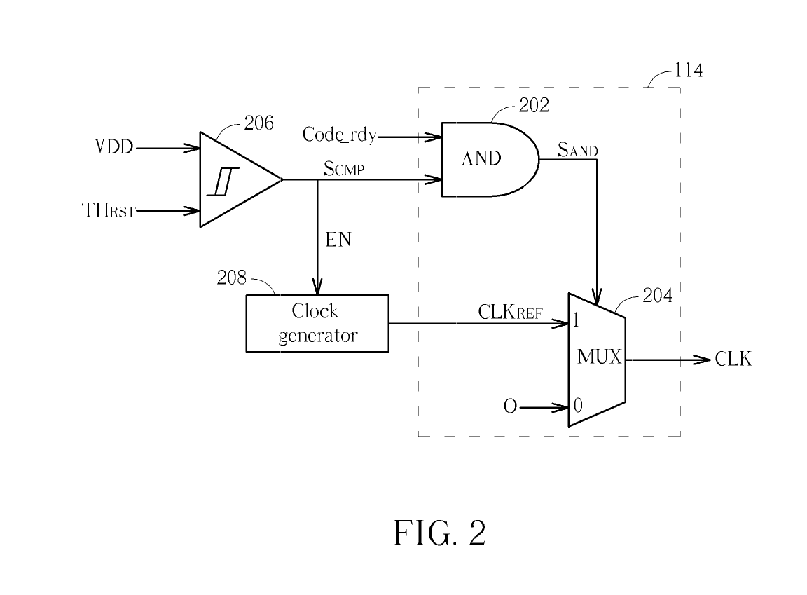

Please refer to FIG. 2, which is a diagram illustrating an embodiment of the clock gating unit 114 shown in FIG. 1. As shown in the figure, the clock gating unit 114 includes an AND gate 202 and a multiplexer (MUX) 204. In one exemplary design, a hysteresis comparator 206 and a clock generator 208 may be integrated in the touch controller chip 106. In another exemplary design, the hysteresis comparator 206 and the clock generator 208 may be external circuit elements of the touch controller chip 106. The hysteresis comparator 206 compares the system supply voltage VDD with a reset threshold TH_{RST} to generate a comparator output S_{CMP}. When the system supply voltage VDD is increased and then stabilized after the system is powered on, the comparator output S_{CMP} generated from the hysteresis comparator 206 would have a high logic level ‘1’. The comparator output S_{CMP} is fed into the AND gate 202 and the clock generator 208. As shown in FIG. 2, the comparator output S_{CMP} also serves as an enable signal EN of the clock generator 208. Hence, when the comparator output S_{CMP} has the high logic level ‘1’, meaning that the supply voltage VDD is stable, the clock generator 208 is thus enabled to generate a reference clock CLK_{REF} with a predetermined frequency. Specifically, the predetermined frequency would satisfy the clock frequency requirement of the control unit 113. Please note that the transmission path between the clock generator 208 and the control unit 113 is controlled by the clock gating unit 114.

In addition to the comparator output S_{CMP}, the AND gate 202 further receives a control signal Code_rdy from a control register of the touch controller chip 106. That is, the logic level of the control signal Code_rdy depends on the logic value, either ‘1’ or ‘0’, stored in the control register. The logic output S_{AND} serves as a control signal of the MUX 204. Hence, when the logic output S_{AND} has the high logic level ‘1’, the MUX 204 outputs the reference clock CLK_{REF} as the clock signal CLK (i.e., CLK=CLK_{REF}). When the logic output S_{AND} has the low logic level ‘0’, the MUX 204 outputs a constant logic level (e.g., ‘0’) as the clock signal CLK (e.g., CLK=‘0’), thus achieving gating of the clock signal CLK. When the clock signal CLK is gated, the control unit 113 is locked/halted due to absence of periodical clock edge transitions. As the logic output S_{AND} is dominated by the setting of the control signal Code_rdy, the clock gating function of the clock gating unit 114 may be regarded as being controlled by the control signal Code_rdy.

To put it simply, the clock gating unit 114 is arranged for receiving a clock signal CLK_{REF}, and selectively gating the clock signal CLK_{REF} from being supplied to the control unit 113 or allowing the clock signal CLK_{REF} to be supplied to the control unit 113 according to the control signal Code_rdy. When the touch controller chip 106 is powered on, the control signal Code_rdy is set by a default value (e.g., ‘0’) stored in the control register such that the clock gating function of the clock gating unit 114 is enabled to prevent the clock signal CLK_{REF} from arriving at the control unit 113.

In this embodiment, the clock gating function of the clock gating unit 114 will be disabled by the host 102 to allow the control unit 113 to operate normally according to the clock signal CLK_{REF}. Specifically, in addition transmitting firmware data of the requested touch controller firmware FW, the host 102 further transmits a control value SC to the touch controller chip 106 to set the control signal Code_rdy. When the control signal Code_rdy is set by the control value SC (e.g., ‘1’) which overwrites the default value (e.g., ‘0’) in the control register, the clock signal CLK_{REF} is supplied to the control unit 113 through the clock gating unit 114. For example, the host 102 may monitor the transmission of the touch controller firmware FW to decide when to generate the control value SC to the touch controller chip 106.

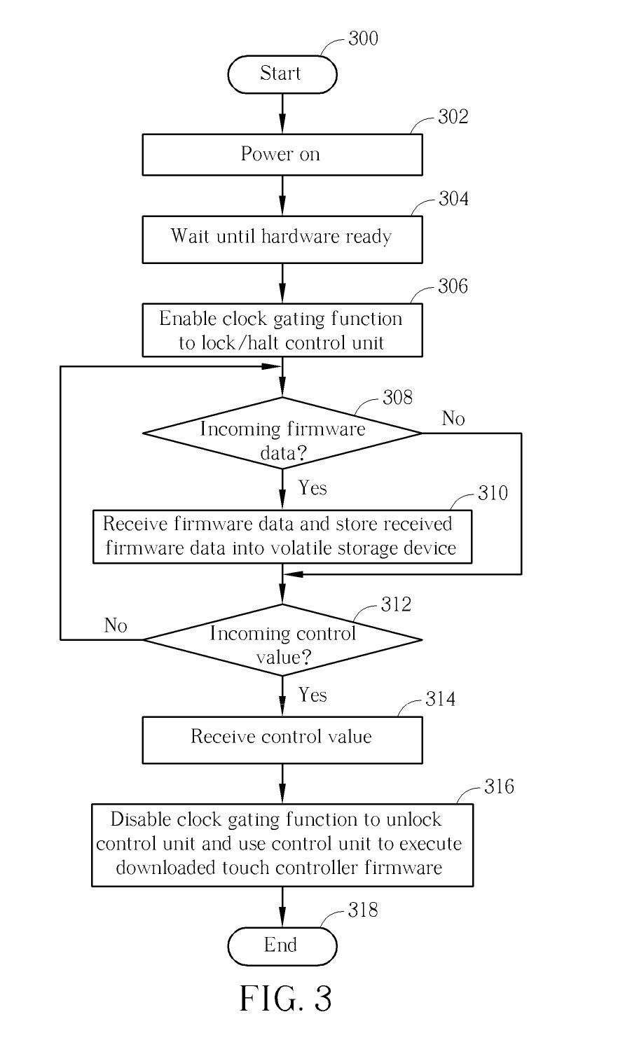

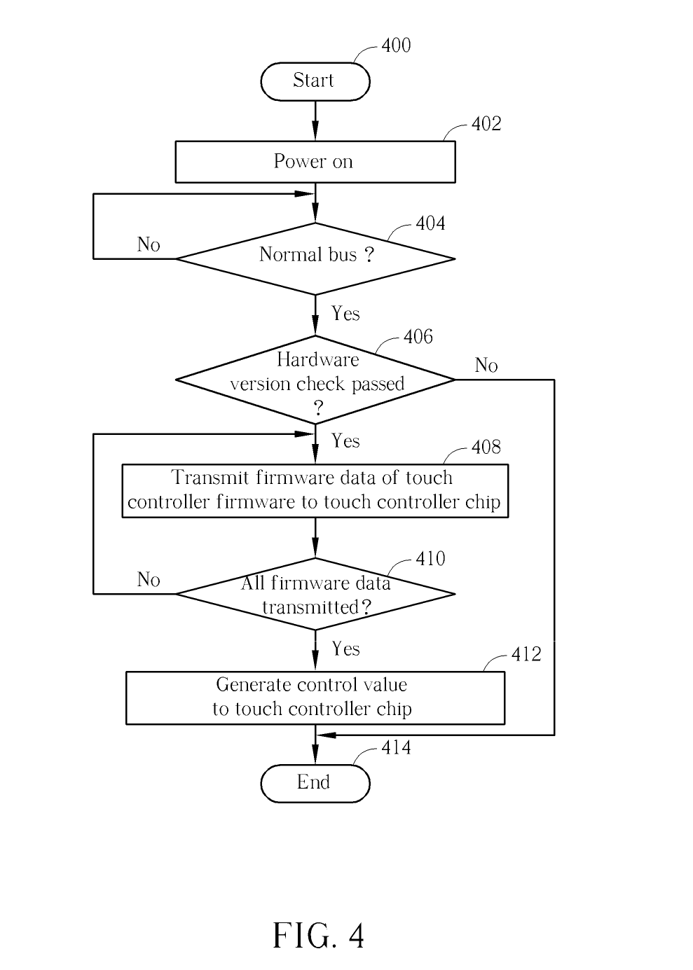

Please refer to FIG. 3 in conjunction with FIG. 4. FIG. 3 is a flowchart illustrating a method performed on a touch controller chip for receiving the touch controller firmware FW and the control value SC from a host according to a first embodiment of the present invention. FIG. 4 is a flowchart illustrating a method performed on a host for transmitting the touch controller firmware FW and the control value SC to the touch controller chip according to a first embodiment of the present invention. If the result is substantially the same, the steps are not required to be executed in the exact order shown in FIG. 3/FIG. 4. The exemplary method performed on the touch controller chip 106 may be briefly summarized as below.

Step 300: Start.

Step 302: Power on.

Step 304: Wait until the hardware is ready.

Step 306: Enable the clock gating function to lock/halt a control unit.

Step 308: Check if there is any firmware data transmitted from a host. If yes, go to step 310; otherwise, go to step 312.

Step 310: Receive the firmware data and store the received firmware data into a volatile storage device.

Step 312: Check if the control value SC is transmitted from the host. If yes, go to step 314; otherwise, go to step 308.

Step 314: Receive the control value SC.

Step 316: Disable the clock gating function to unlock the control unit, and use the control unit to execute the touch controller firmware FW stored in the volatile storage device.

Step 318: End.

The exemplary method performed on the host 102 may be briefly summarized as below.

Step 400: Start.

Step 402: Power on.

Step 404: Check if a bus (e.g., an I2C bus) between a host and a touch controller chip is normal. If yes, go to step 406; otherwise, perform step 404 again.

Step 406: Check if the touch controller chip passes a hardware version check. If yes, go to step 408; otherwise, go to step 414.

Step 408: Transmit firmware data of the touch controller firmware FW to the touch controller chip.

Step 410: Check if all of firmware data of the touch controller firmware FW has been transmitted to the touch controller chip. If yes, go to step 412; otherwise, go to step 408 to keep sending the remaining firmware data.

Step 412: Generate the control value SC to the touch controller chip.

Step 414: End.

When the system (i.e., the electronic device 100) is powered on, the host 102 and the touch controller chip 106 are powered on (steps 302 and 402). Hence, all of the hardware elements in the touch controller chip 106 would be started up due to the non-zero supply voltage. The touch controller chip 106 waits before the hardware is ready (step 304). For example, when the hardware is ready, the bus (e.g., the I2C bus) between the host 102 and the touch controller chip 106 may be successfully established. With regard to the host 102, it will check if the bus (e.g., the I2C bus) between the host 102 and the touch controller chip 106 is normally established after powered on (step 404). When it is determined that the bus is normal and can be used for data transmission, the host 102 further checks a hardware version of the touch controller chip 106 to avoid mistakenly transmitting the touch controller firmware FW to a different/incompatible touch controller chip (step 406). When it is determined that the hardware version is correct, the host 102 starts transmitting the firmware data to the touch controller chip 106 and the touch controller chip 106 starts receiving the firmware data from the host 102 (steps 308, 310 and 408). When all of the firmware data of the touch controller firmware FW has been transmitted from the host 102 to the touch controller chip 106, the host 102 generates the control value SC to the touch controller chip 106, and the touch controller chip 106 receives the control value SC (steps 312, 314, 410 and 412). Next, the control unit 113 is unlocked by the control value SC to execute the touch controller firmware FW for controlling the touch panel 108 (step 316).

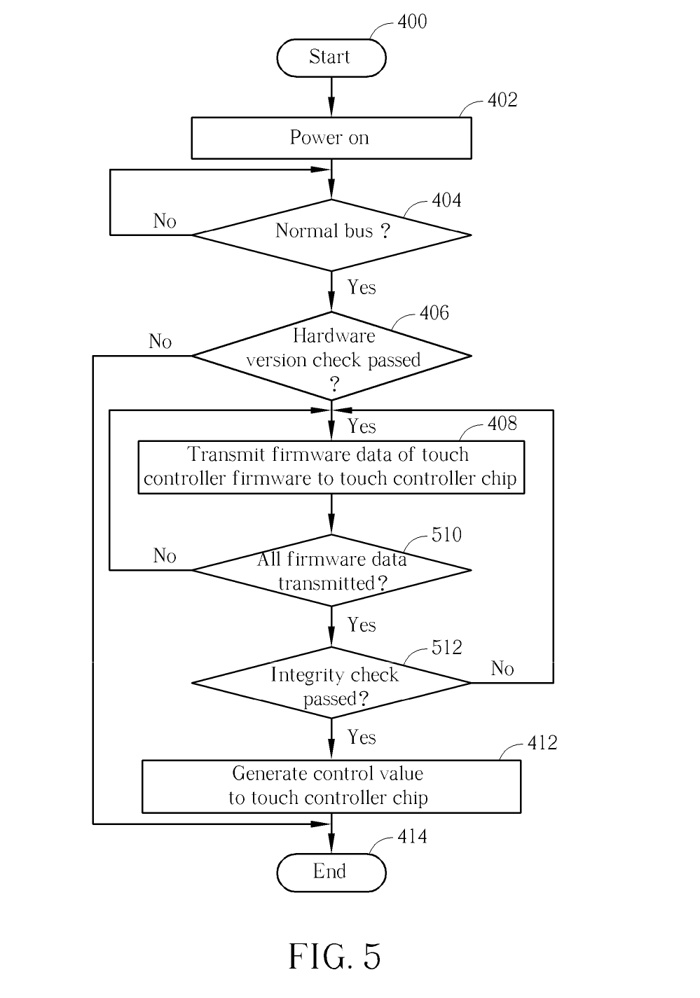

In above embodiment, the host 102 generates the control value SC at the end of firmware data transmission of the touch controller firmware FW. That is, the host 102 does not generate the control value SC until the firmware data transmission is finished. However, this is for illustrative purposes only. Alternatively, the control value SC may be transmitted after the integrity of the touch controller firmware FW received by the touch controller chip 106 is verified. Please refer to FIG. 5, which is a flowchart illustrating a method performed on a host for transmitting the touch controller firmware FW and the control value SC to a touch controller chip according to a second embodiment of the present invention. If the result is substantially the same, the steps are not required to be executed in the exact order shown in FIG. 5. The major difference between the methods shown in FIG. 5 and FIG. 4 is that the control value SC is not transmitted until the touch controller firmware FW received by the touch controller chip 106 passes the integrity check. Specifically, when all of the firmware data of the touch controller firmware FW has been transmitted to the touch controller chip 106 (step 510), the host 102 reads the touch controller firmware FW from the volatile storage device 112 in the touch controller chip 106, and compares the touch controller firmware stored in the host 102 and the touch controller firmware FW received by the touch controller chip 106 for checking integrity of the touch controller firmware FW received by the touch controller chip (step 512). When the touch controller firmware FW passes the integrity check, the control value SC is transmitted to the touch controller chip 106 (step 412). However, when the touch controller firmware FW received by the touch controller chip 106 fails to pass the integrity check, meaning that the touch controller firmware FW in the touch controller firmware FW may contain error bits, the flow proceeds with step 408 to re-transmit at least a portion (e.g., part or all) of the touch controller firmware FW to the touch controller chip 106.

Hence, when the method shown in FIG. 3 is employed by the touch controller chip 106 and the method shown in FIG. 5 is employed by the host 102, the same objective of downloading the touch controller firmware from the external host and then executing the downloaded touch controller firmware to control the touch panel is achieved.

Regarding the electronic device 100 shown in FIG. 1, the locking and unlocking of the control unit 113 is controlled by the clock gating unit 114, where the clock gating function is disabled in response to the control value SC generated from the host 102. However, this is for illustrative purposes only. Alternatively, the locking and unlocking of a control unit may be controlled by an enable signal of the control unit.

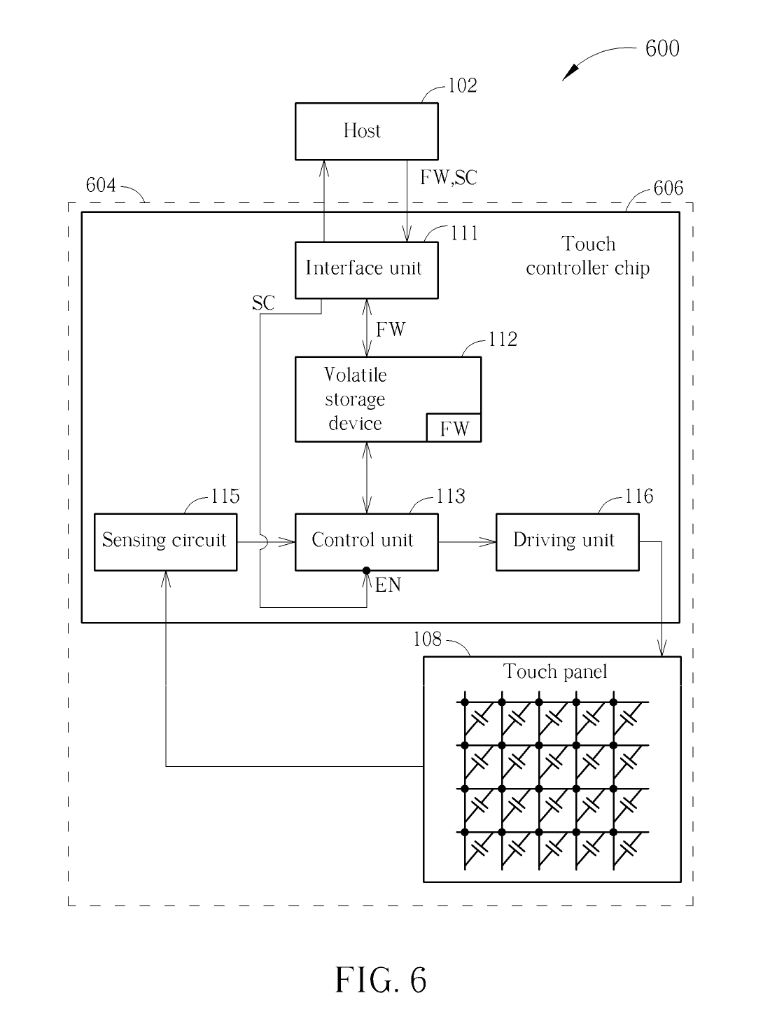

FIG. 6 is a block diagram illustrating an electronic apparatus employing a proposed touch controller design according to a second embodiment of the present invention. The electronic apparatus 600 has the host 102 and a touch panel device 604, where the touch panel device 604 includes a touch controller chip 606 and the touch panel 108. In this embodiment, the host 102 may communicate with the touch controller chip 606 through an SPI bus. The major difference between the electronic apparatuses 600 and 100 is that the clock gating unit 114 is omitted and the control value SC generated by the host 102 is used to set an enable signal of the control unit 113.

Similarly, before the touch controller firmware FW is ready for execution on the touch controller chip 606, the control unit 113 should be stopped from loading and executing the incomplete touch controller firmware. Specifically, the control unit 113 is initially locked (halted) by default when the touch controller chip 606 is powered on, and is unlocked later for executing the touch controller firmware FW provided by the host 102 to control the touch panel 108. In this embodiment, locking and unlocking of the control unit 113 is controlled by the control signal EN acting as an enable signal of the control unit 113. The control unit 113 receives the control signal EN from a control register of the touch controller chip 606. That is, the logic level of the control signal EN depends on the logic value, either ‘1’ or ‘0’, stored in the control register. In this embodiment, when the touch controller chip 606 is powered on, the control signal EN is set by a default value (e.g., ‘0’) stored in the control register such that the control unit 113 is disabled correspondingly. When the control value SC is received from the host 102, the control signal EN is set by the control value SC (e.g., ‘1’) which overwrites the default value (e.g., ‘0’) in the control register. Hence, the control unit 113 is enabled to execute the touch controller firmware FM in the volatile storage device 112.

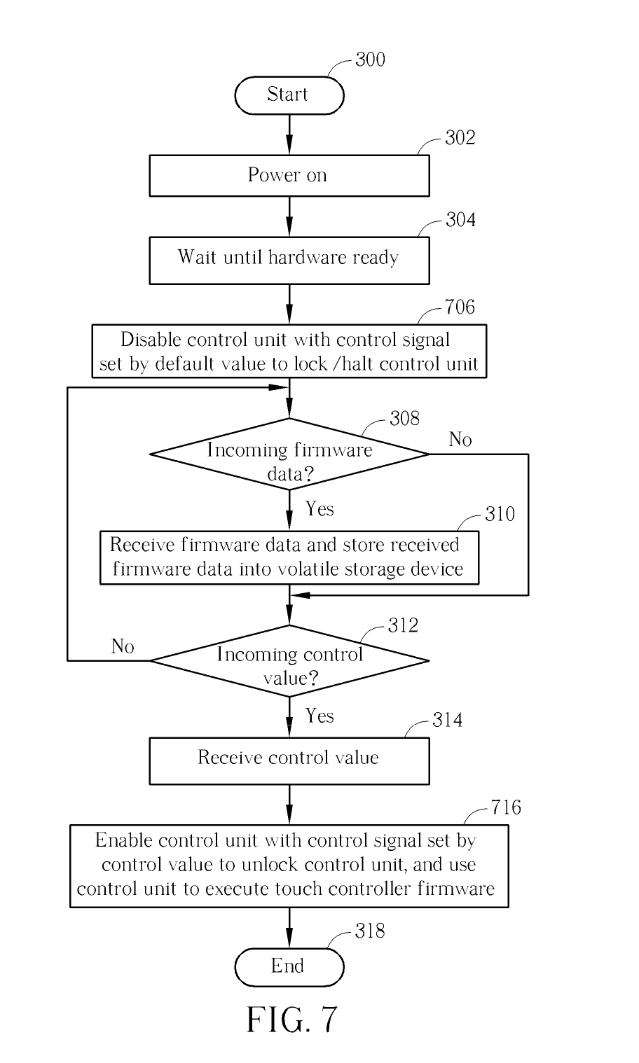

Please refer to FIG. 7, which is a flowchart illustrating a method performed on a touch controller chip for receiving the touch controller firmware FW and the control value SC from a host according to a second embodiment of the present invention. If the result is substantially the same, the steps are not required to be executed in the exact order shown in FIG. 7. The major difference between the methods shown in FIG. 7 and FIG. 3 is that step 706 is executed to lock/halt the control unit 113 by disabling the control unit 113 with the control signal EN set by a default value (e.g., ‘0’), and step 716 is executed to unlock the control unit 113 by enabling the control unit 113 with the control signal EN set by the control value (e.g., ‘1’) generated from the host 102.

When the method shown in FIG. 7 is employed by the touch controller chip 606, the method shown in FIG. 4 or FIG. 5 may be employed by the host 102. The same objective of downloading the touch controller firmware from the external host and then executing the downloaded touch controller firmware to control the touch panel is achieved.

Regarding the electronic devices 100, 600 shown in FIG. 1 and FIG. 6, the control value SC used to unlock the control unit 113 is generated from the host 102 by checking integrity or transmission of the touch controller firmware FW. However, this is for illustrative purposes only. Alternatively, the control value SC used to unlock the control unit 113 may be generated from an internal element of the touch controller chip 606. Several examples are given as below.

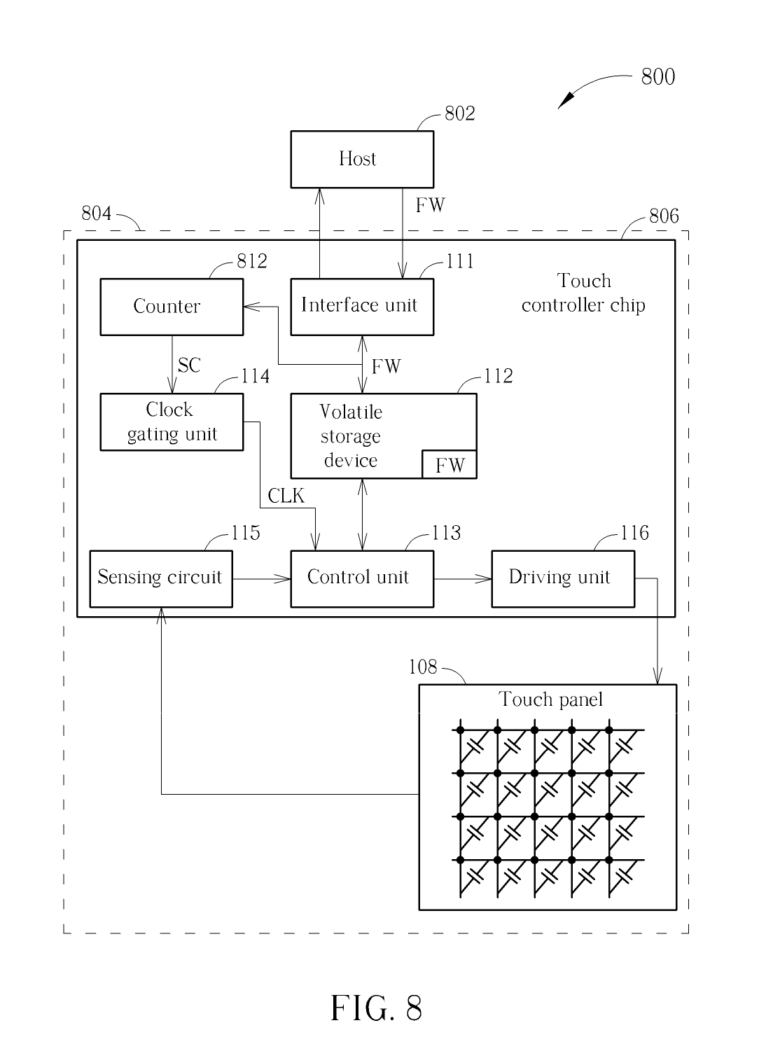

FIG. 8 is a block diagram illustrating an electronic apparatus employing a proposed touch controller design according to a third embodiment of the present invention. The electronic apparatus 800 has a host 802 and a touch panel device 804, where the touch panel device 804 includes a touch controller chip 806 and the touch panel 108. In this embodiment, the host 802 may communicate with the touch controller chip 806 through an I2C bus. The major difference between the electronic apparatuses 800 and 100 is that the host 802 does not need to generate the control value SC, and the touch controller chip 806 is therefore responsible for generating the control value SC. In this embodiment, the touch controller chip 806 is configured to have a counter 812 arranged for counting a length of firmware data transmitted from the host 802, and generating the control value SC to set the control signal (e.g., Code_rdy shown in FIG. 2) when the length of firmware data reaches a predetermined value (e.g., the data amount of the touch controller firmware FW). Specifically, when the control signal Code_rdy is set by the control value SC (e.g., ‘1’), the clock signal (e.g., CLK_{REF} generated from the clock generator 208 in FIG. 2) is supplied to the control unit 113 through the clock gating unit 114.

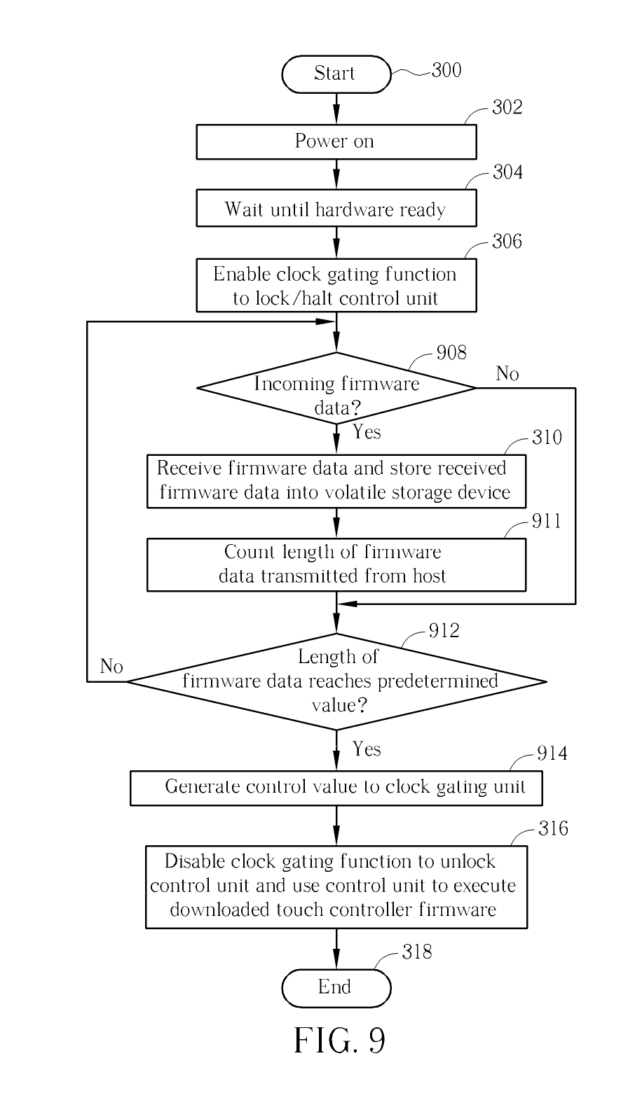

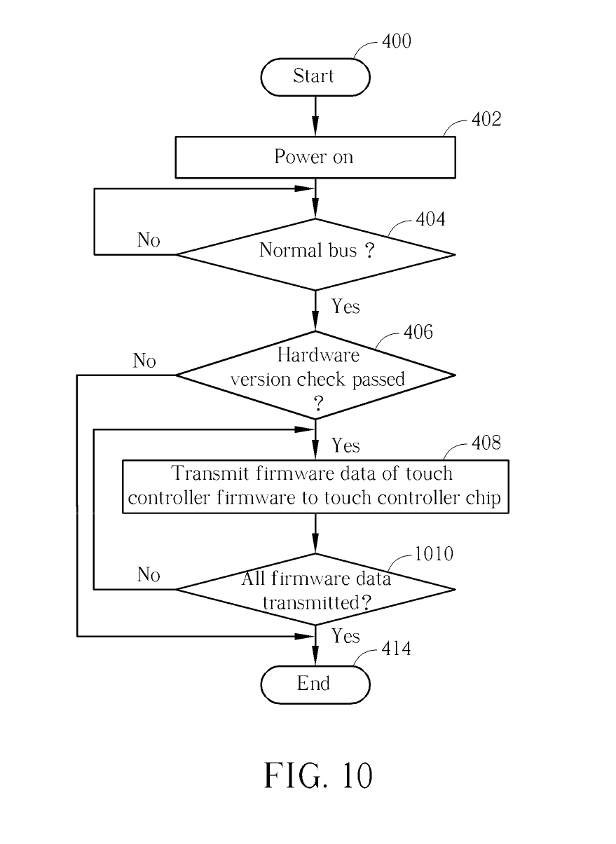

Please refer to FIG. 9 in conjunction with FIG. 10. FIG. 9 is a flowchart illustrating a method performed on a touch controller chip for receiving the touch controller firmware FW and generating the control value SC according to a first embodiment of the present invention. FIG. 10 is a flowchart illustrating a method performed on a host for transmitting the touch controller firmware FW to the touch controller chip according to a first embodiment of the present invention. If the result is substantially the same, the steps are not required to be executed in the exact order shown in FIG. 9/FIG. 10. The method performed on the touch controller chip 806 may be briefly summarized as below.

Step 300: Start.

Step 302: Power on.

Step 304: Wait until the hardware is ready.

Step 306: Enable the clock gating function to lock/halt the control unit.

Step 908: Check if there is any firmware data transmitted from the host. If yes, go to step 310; otherwise, go to step 912.

Step 310: Receive the firmware data and store the received firmware data into the volatile storage device.

Step 911: Count a length of firmware data transmitted from the host.

Step 912: Check if the length of firmware data reaches a predetermined value. If yes, go to step 914; otherwise, go to step 908.

Step 914: Generate the control value SC to the clock gating unit.

Step 316: Disable the clock gating function to unlock the control unit, and use the control unit to execute the touch controller firmware FW stored in the volatile storage device.

Step 318: End.

The method performed on the host 802 may be briefly summarized as below.

Step 400: Start.

Step 402: Power on.

Step 404: Check if a bus (e.g., an I2C bus) between the host and the touch controller chip is normal. If yes, go to step 406; otherwise, perform step 404 to keep waiting for a normal bus established between the host 102 and the touch controller chip.

Step 406: Check if the touch controller chip passes a hardware version check. If yes, go to step 408; otherwise, go to step 414.

Step 408: Transmit firmware data of the touch controller firmware FW to the touch controller chip.

Step 1010: Check if all of the firmware data of the touch controller firmware FW has been transmitted to the touch controller chip. If yes, go to step 414; otherwise, go to step 408 to keep sending the remaining firmware data.

Step 414: End.

The major difference between the methods shown in FIG. 9 and FIG. 3 is that the length of the firmware data transmitted from the host is counted by the counter 812 disposed in the touch controller chip 806, and the control value SC is generated from the counter 812 when the length of firmware data reaches a predetermined value (e.g., the control value SC is generated when all of the firmware data of the touch controller firmware FW has been received). Besides, the major difference between the methods shown in FIG. 9 and FIG. 4/FIG. 5 is that the there is no step executed by the host for generating the control value SC and/or checking the integrity of the firmware data received by the touch controller chip.

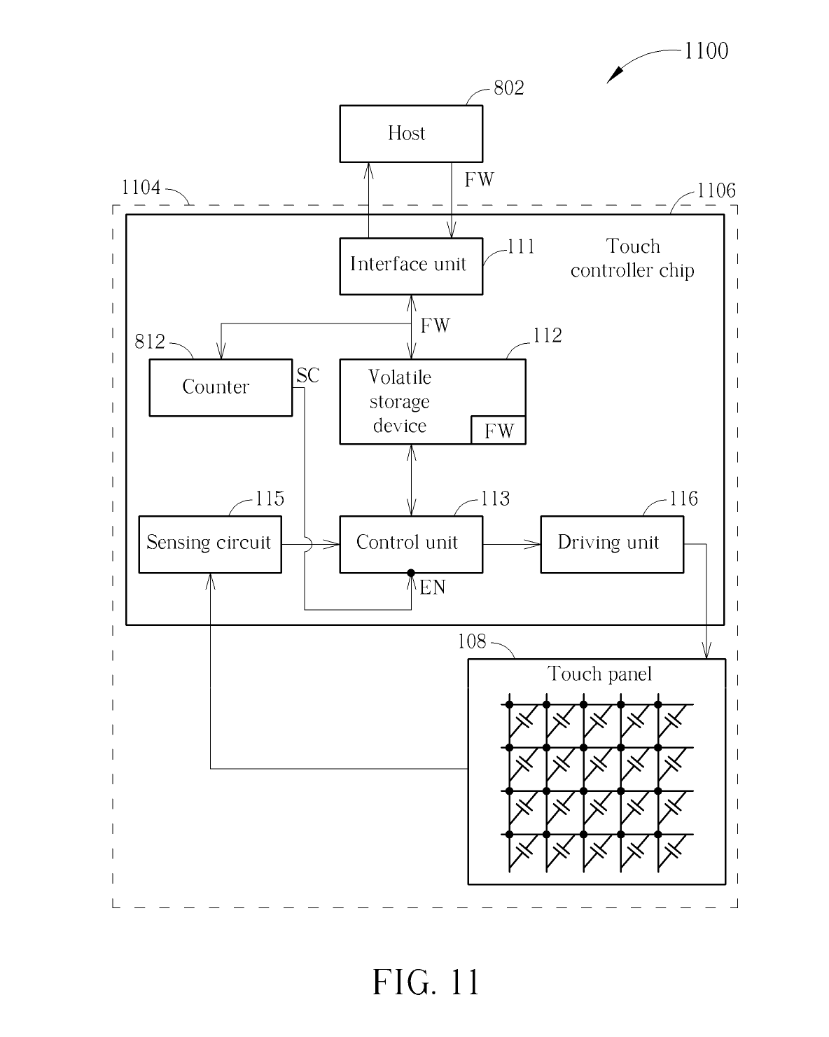

As mentioned above, the locking and unlocking of a control unit may be controlled by an enable signal of the control unit. Please refer to FIG. 11, which is a block diagram illustrating an electronic apparatus employing a proposed touch controller design according to a fourth embodiment of the present invention. The electronic apparatus 1100 has the host 802 and a touch panel device 1104, where the touch panel device 1104 includes a touch controller chip 1106 and the touch panel 108. In this embodiment, the host 802 may communicate with the touch controller chip 1106 through an SPI bus. The major difference between the electronic apparatuses 1100 and 800 is that the clock gating unit 114 is omitted and the control value SC generated by the counter 812 is used to set the enable signal of the control unit 113. Specifically, when the touch controller chip 1106 is powered on, the control signal EN is set by a default value (e.g., ‘0’) stored in the control register such that the control unit 113 is disabled. When the control value SC is generated from the counter 812, the control signal EN is set by the control value SC (e.g., ‘1’) which overwrites the default value (e.g., ‘0’) in the control register. Hence, the control unit 113 is enabled to execute the touch controller firmware FM in the volatile storage device 112.

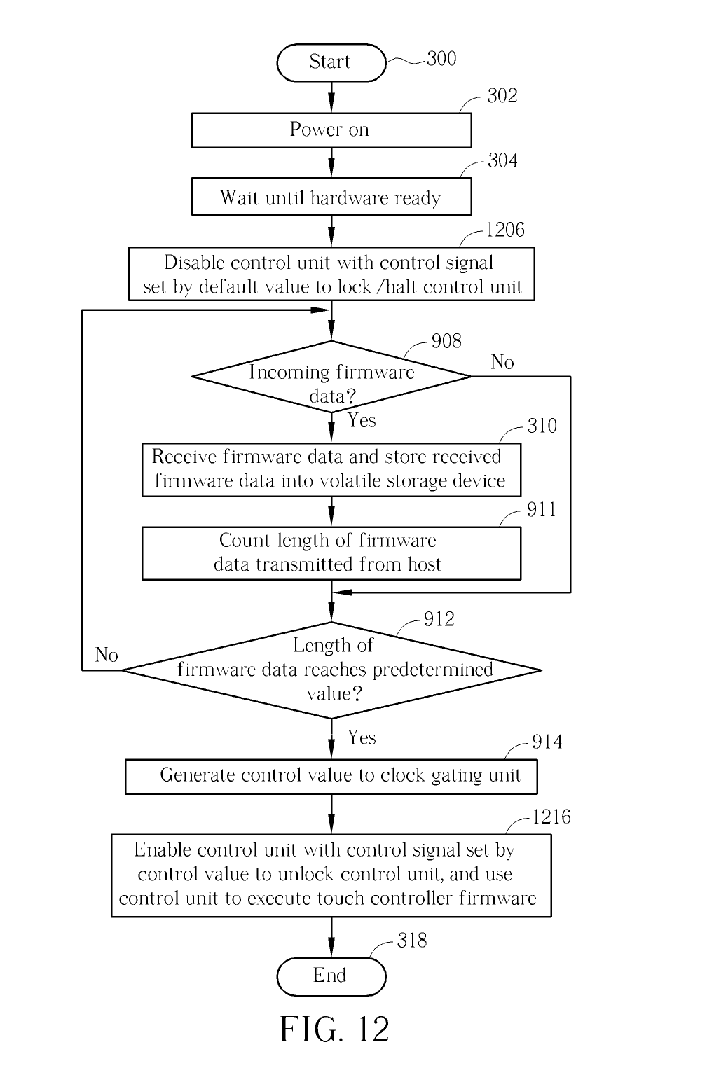

Please refer to FIG. 12, which is a flowchart illustrating a method performed on a touch controller chip for receiving the touch controller firmware FW and generating the control value SC according to a second embodiment of the present invention. If the result is substantially the same, the steps are not required to be executed in the exact order shown in FIG. 12. The major difference between the methods shown in FIG. 12 and FIG. 9 is that step 1206 is executed to lock/halt the control unit 113 by disabling the control unit 113 with the control signal EN set by a default value (e.g., ‘0’), and step 1216 is executed to unlock the control unit 113 by enabling the control unit 113 with the control signal EN set by the control value (e.g., ‘1’) generated from the counter 812.

When the method shown in FIG. 12 is employed by the touch controller chip 1106, the method shown in FIG. 10 may be employed by the host 802. Hence, the same objective of downloading the touch controller firmware from the external host and then executing the downloaded touch controller firmware to control the touch panel is achieved.

Regarding the electronic device 800/1100 shown in FIG. 8/FIG. 11, the control value SC used to unlock the control unit 113 is generated from the counter 812 disposed in the touch controller chip 806/1106. However, this is for illustrative purposes only. Alternatively, the control value SC used to unlock the control unit 113 may be generated from a different internal element of the touch controller chip 806/1106.

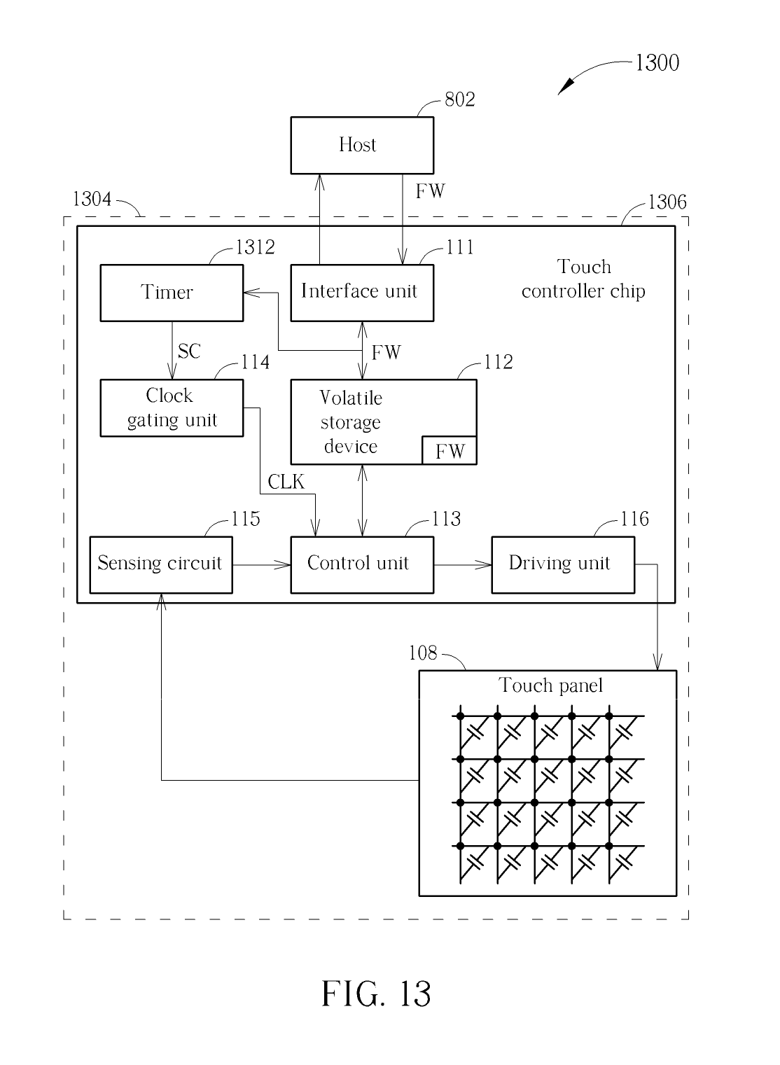

FIG. 13 is a block diagram illustrating an electronic apparatus employing a proposed touch controller design according to a fifth embodiment of the present invention. The electronic apparatus 1300 has the host 802 and a touch panel device 1304, where the touch panel device 1304 includes a touch controller chip 1306 and the touch panel 108. In this embodiment, the host 802 may communicate with the touch controller chip 1306 through an I2C bus. The major difference between the electronic apparatuses 1300 and 800 is that the counter 812 is replaced by a timer 1312, where the timer 1312 is arranged for counting a transmission time of firmware data transmitted from the host 802, and generating the control value SC to set the control signal (e.g., Code_rdy shown in FIG. 2) when the transmission time of firmware data reaches a predetermined value (e.g., an estimated time period needed for transmitting the touch controller firmware FWO). Specifically, when the control signal Code_rdy is set by the control value SC, the clock signal (e.g., CLK_{REF} generated from the clock generator 208 in FIG. 2) is supplied to the control unit 113 through the clock gating unit 114.

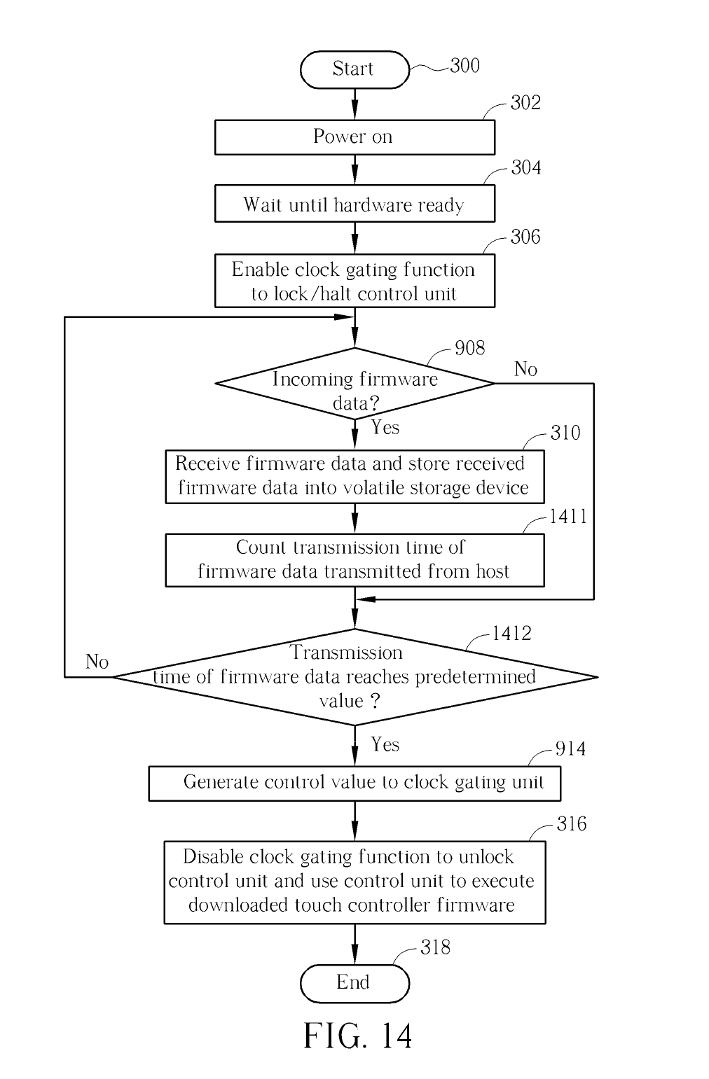

Please refer to FIG. 14, which is a flowchart illustrating a method performed on a touch controller chip for receiving the touch controller firmware FW and generating the control value SC according to a third embodiment of the present invention. If the result is substantially the same, the steps are not required to be executed in the exact order shown in FIG. 14. The major difference between the methods shown in FIG. 14 and FIG. 9 is that step 1411 is executed to count the transmission time of firmware data transmitted from the host 802, and step 914 generates the control value SC when step 1412 determines that the transmission time of firmware data reaches the predetermined value.

When the method shown in FIG. 14 is employed by the touch controller chip 1306, the method shown in FIG. 10 may be employed by the host 802. Hence, the same objective of downloading the touch controller firmware from the external host and then executing the downloaded touch controller firmware to control the touch panel is achieved.

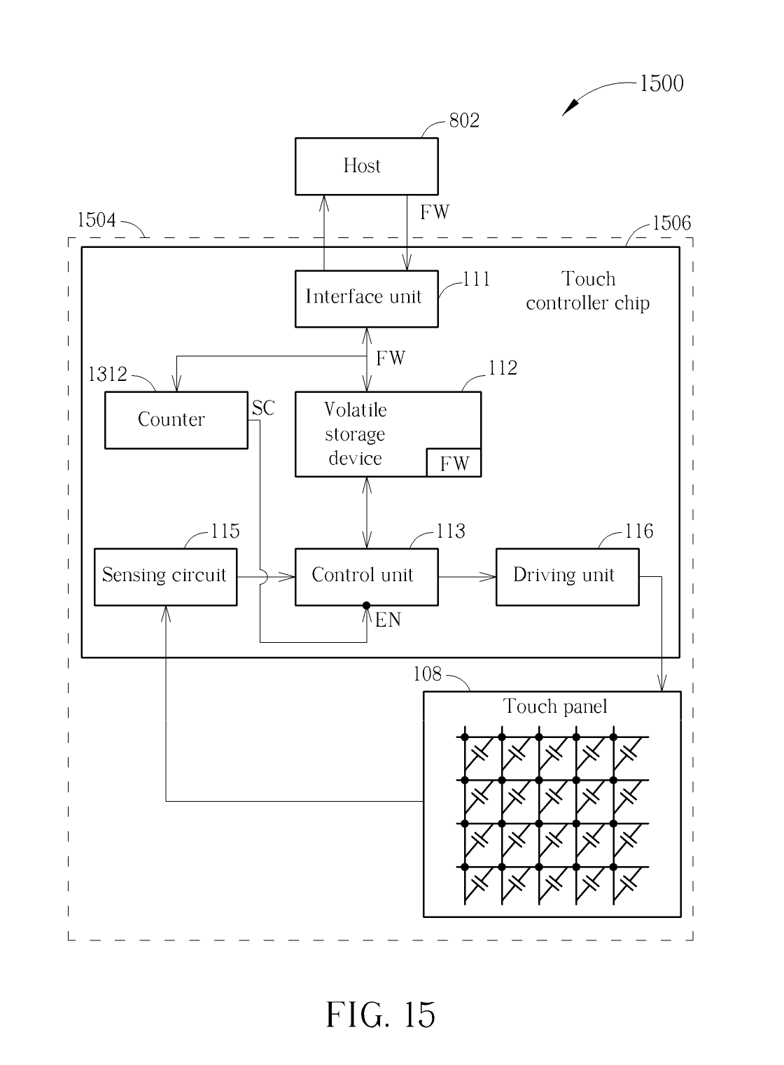

As mentioned above, the locking and unlocking of a control unit may be controlled by an enable signal of the control unit. Please refer to FIG. 15, which is a block diagram illustrating an electronic apparatus employing a proposed touch controller design according to a sixth embodiment of the present invention. The electronic apparatus 1500 has the host 802 and a touch panel device 1504, where the touch panel device 1504 includes a touch controller chip 1506 and the touch panel 108. In this embodiment, the host 802 may communicate with the touch controller chip 1506 through an SPI bus. The major difference between the electronic apparatuses 1500 and 1300 is that the clock gating unit 114 is omitted and the control value SC generated by the timer 1312 is used to set an enable signal of the control unit 113. Specifically, when the touch controller chip 1506 is powered on, the control signal EN is set by a default value (e.g., ‘0’) stored in the control register such that the control unit 113 is disabled. When the control value SC is generated from the timer 1312, the control signal EN is set by the control value SC (e.g., ‘1’) which overwrites the default value (e.g., ‘0’) in the control register. Hence, the control unit 113 is enabled to execute the touch controller firmware FM in the volatile storage device 112.

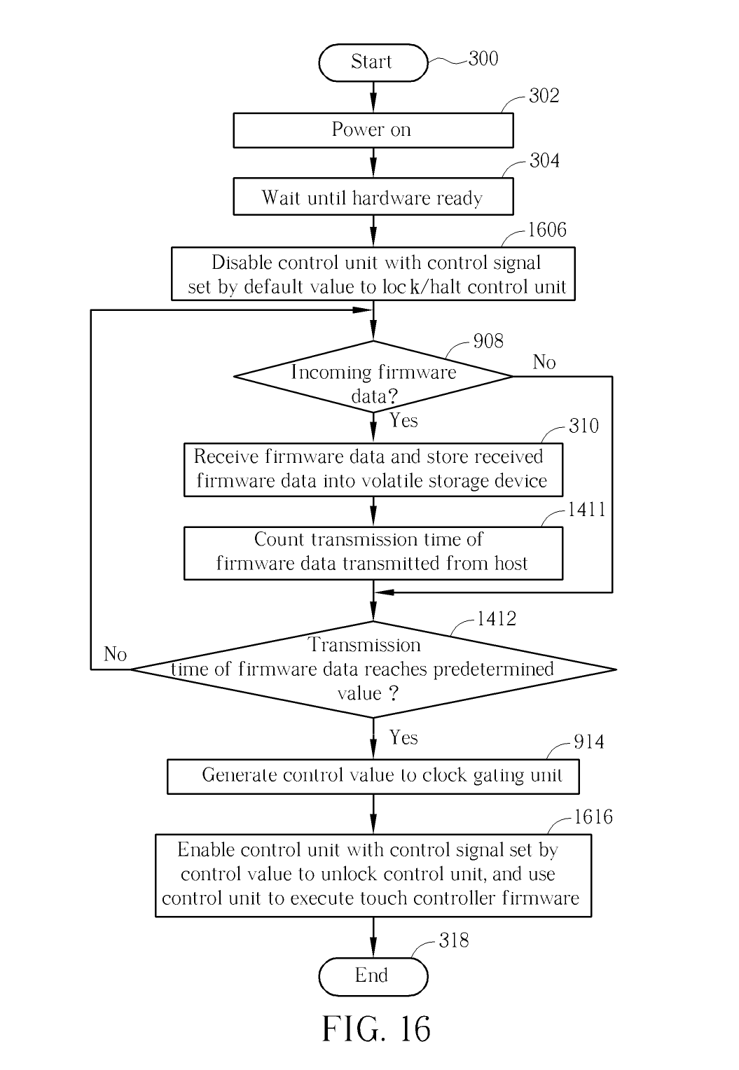

Please refer to FIG. 16, which is a flowchart illustrating a method performed on a touch controller chip for receiving the touch controller firmware FW and generating the control value SC according to a fourth embodiment of the present invention. If the result is substantially the same, the steps are not required to be executed in the exact order shown in FIG. 16. The major difference between the methods shown in FIG. 16 and FIG. 14 is that step 1606 is executed to lock/halt the control unit 113 by disabling the control unit 113 with the control signal EN set by a default value (e.g., ‘0’), and step 1616 is executed to unlock the control unit 113 by enabling the control unit 113 with the control signal EN set by the control value (e.g., ‘1’) generated from the timer 1312.

When the method shown in FIG. 16 is employed by the touch controller chip 1506, the method shown in FIG. 10 may be employed by the host 802. Hence, the same objective of downloading the touch controller firmware from the external host and then executing the downloaded touch controller firmware to control the touch panel is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch controller chip, comprising:
a volatile storage device;
an interface unit, arranged for receiving touch controller firmware outside the touch controller chip, and storing the received touch controller firmware into the volatile storage device; and
a control unit, arranged for executing the touch controller firmware stored in the volatile storage device to control a touch panel.

2. The touch controller chip of claim 1, wherein the control unit is initially locked by default when the touch controller chip is powered on, and is unlocked later for executing the touch controller firmware.

3. The touch controller chip of claim 2, further comprising:
a clock gating unit, arranged for receiving a clock signal, and selectively gating a clock signal from being supplied to the control unit or allowing the clock signal to be supplied to the control unit according to a control signal, wherein when the touch controller chip is powered on, the control signal is set by a default value such that the clock signal is gated by the clock gating unit.

4. The touch controller chip of claim 3, wherein the interface unit is further arranged for receiving a control value outside the touch controller chip to set the control signal; and when the control signal is set by the control value, the clock signal is supplied to the control unit through the clock gating unit.

5. The touch controller chip of claim 3, further comprising:
a counter, arranged for counting a length of firmware data transmitted from the host, and generates a control value to set the control signal when the length of firmware data reaches a predetermined value; wherein when the control signal is set by the control value, the clock signal is supplied to the control unit through the clock gating unit.

6. The touch controller chip of claim 3, further comprising:
a timer, arranged for counting a transmission time of firmware data transmitted from the host, and generates a control value to set the control signal when the transmission time of firmware data reaches a predetermined value; wherein when the control signal is set by the control value, the clock signal is supplied to the control unit through the clock gating unit.

7. The touch controller chip of claim 2, wherein the control unit receives a control signal, and the control unit is selectively enabled or disabled according to the control signal; and when the touch controller chip is powered on, the control signal is set by a default value such that the control unit is disabled.

8. The touch controller chip of claim 7, wherein the interface unit is further arranged for receiving a control value outside the touch controller chip to set the control signal; and when the control signal is set by the control value, the control unit is enabled.

9. The touch controller chip of claim 7, further comprising:
a counter, arranged for counting a length of firmware data transmitted from the host, and generates a control value to set the control signal when the length of firmware data reaches a predetermined value; wherein when the control signal is set by the control value, the control unit is enabled.

10. The touch controller chip of claim 7, further comprising:
a timer, arranged for counting a transmission time of firmware data transmitted from the host, and generates a control value to set the control signal when the transmission time of firmware data reaches a predetermined value; wherein when the control signal is set by the control value, the control unit is enabled.

11. An electronic device, comprising:
a touch controller chip, wherein the touch controller chip has no non-volatile storage device used for storing touch controller firmware; and
a host, arranged for transmitting the touch controller firmware to the touch controller chip.

12. The electronic device of claim 11, wherein the host is further arranged for checking a hardware version of the touch controller chip; and the host is allowed to transmit the touch controller firmware to the touch controller chip when the touch controller chip passes a hardware version check.

13. The electronic device of claim 11, wherein the touch controller chip comprises a control unit; and the control unit is initially locked by default when the touch controller chip is powered on, and is unlocked later for executing the touch controller firmware provided by the host to control a touch panel.

14. The electronic device of claim 13, wherein the touch controller chip further comprises:
a clock gating unit, arranged for receiving a clock signal, and selectively gating a clock signal from being supplied to the control unit or allowing the clock signal to be supplied to the control unit according to a control signal, wherein when the touch controller chip is powered on, the control signal is set by a default value such that the clock signal is gated by the clock gating unit.

15. The electronic device of claim 14, wherein the host is further arranged for transmitting a control value to the touch controller chip to set the control signal; and when the control signal is set by the control value, the clock signal is supplied to the control unit through the clock gating unit.

16. The electronic device of claim 15, wherein the host is further arranged for checking integrity of the touch controller firmware received by the touch controller chip; and the control value is transmitted to the touch controller chip when the touch controller firmware passes an integrity check.

17. The electronic device of claim 15, wherein the host is further arranged for checking if all of the touch controller firmware is transmitted to the touch controller chip; and the control value is transmitted to the touch controller chip when transmission of the touch controller firmware is finished.

18. The electronic device of claim 14, wherein the touch controller chip further comprises:
a counter, arranged for counting a length of firmware data transmitted from the host, and generates a control value to set the control signal when the length of firmware data reaches a predetermined value; wherein when the control signal is set by the control value, the clock signal is supplied to the control unit through the clock gating unit.

19. The electronic device of claim 14, wherein the touch controller chip further comprises:
a timer, arranged for counting a transmission time of firmware data transmitted from the host, and generates a control value to set the control signal when the transmission time of firmware data reaches a predetermined value; wherein when the control signal is set by the control value, the clock signal is supplied to the control unit through the clock gating unit.

20. The electronic device of claim 13, wherein the control unit receives a control signal, and the control unit is selectively enabled or disabled according to the control signal; and when the touch controller chip is powered on, the control signal is set by a default value such that the control unit is disabled.

21. The electronic device of claim 20, wherein the host is further arranged for transmitting a control value to the touch controller chip to set the control signal; and when the control signal is set by the control value, the control unit is enabled.

22. The electronic device of claim 21, wherein the host is further arranged for checking integrity of the touch controller firmware transmitted to the touch controller chip; and the control value is transmitted to the touch controller chip when the touch controller firmware passes an integrity check.

23. The electronic device of claim 21, wherein the host is further arranged for checking if all of the touch controller firmware is transmitted to the touch controller chip; and the control value is transmitted to the touch control when transmission of the touch controller firmware is finished.

24. The electronic device of claim 20, wherein the touch controller chip further comprises:
a counter, arranged for counting a length of firmware data transmitted from the host, and generates a control value to set the control signal when the length of firmware data reaches a predetermined value; wherein when the control signal is set by the control value, the control unit is enabled.

25. The electronic device of claim 20, wherein the touch controller chip further comprises:
a timer, arranged for counting a transmission time of firmware data transmitted from the host, and generates a control value to set the control signal when the transmission time of firmware data reaches a predetermined value; wherein when the control signal is set by the control value, the control unit is enabled.

26. A method for controlling a touch panel, comprising:
downloading touch controller firmware from a first device to a second device, wherein the first device and the second device are not integrated in a same chip; and
executing the touch controller firmware on the second device for controlling the touch panel.
